(19) United States
(12) Patent Application Publication
(10) Pub. No.: US 2011/0105048 A1
(43) Pub. Date: May 5, 2011

(54) RADIO RECEIVING APPARATUS, AND EXTRA-USE-UNIT-BAND REFERENCE SIGNAL MEASUREMENT METHOD

(75) Inventors: Seigo Nakao, Kanagawa (JP); Hidetoshi Suzuki, Kanagawa (JP)

(73) Assignee: Panasonic Corporation, Osaka (JP)

(21) Appl. No.: 13/001,538

(22) PCT Filed: Jul. 14, 2009
(86) PCT No.: PCT/JP2009/003301

§ 371 Date: Dec. 27, 2010

(30) Foreign Application Priority Data
Jul. 15, 2008 (JP) 2008-183732

(51) Int. Cl. H04B 17/00

(52) U.S. Cl. 455/67.14

(57) ABSTRACT

A radio receiving apparatus and a reference signal on an unused unit band measurement method wherein QoS can be maintained and measured in a wireless communication system that simultaneously uses first and second frequency bands, each of which includes a plurality of unit bands, to transmit a series of data signal sequences. In a terminal (100), a measurement executing part (150-1) measures, during a first measurement interval overlapping with the second data reception interval and time-divided together with the first data reception interval, the reception power of a reference signal on an unused unit band transmitted over a unit band other than a first used unit band in the first frequency band. In this way, the terminal (100) can execute a data communication with a source base station (200) over any one of the frequency bands at any timing, which can reduce the delay of a downstream signal transmission. That is, a terminal (100) can be realized which can maintain and measure QoS.

### TECHNICAL FIELD

The present invention relates to a radio receiving apparatus and a reference signal on an unused unit band measuring method, in a radio communication system that transmits a series of data signal sequences using at the same time a first frequency band and a second frequency band each including a plurality of unit bands.

### BACKGROUND ART

3GPP LTE adopts OFDMA (Orthogonal Frequency Division Multiple Access) as a downlink communication scheme. In a radio communication system adopting 3GPP LTE, a radio communication base station apparatus (hereinafter simply called “base station”) transmits a reference signal (“RS”) using predetermined communication resources. Then, a radio communication terminal apparatus (hereinafter simply called “terminal”) performs channel estimation using the received reference signal and demodulates reception data using a channel estimation value (e.g. see Non-Patent Literature 1).

Also, standardization of 3GPP LTE-advanced to realize faster communication than 3GPP LTE has been started. In order to realize downlink transmission speed equal to or greater than maximum 1 Gbps, 3GPP LTE-advanced will adopt a band aggregation scheme to perform communication by grouping a plurality of frequency bands.

FIG. 1 illustrates a band aggregation scheme. As shown in FIG. 1, in a radio communication system adopting the band aggregation scheme, a terminal receives downlink signals per 20 MHz at the same time from base stations in a plurality of frequency bands (e.g. a 2 GHz band and a 3.4 GHz band), and decodes data directed to that terminal. Here, a band having a 20 MHz width and including an SCH (Synchronization CHannel) near the center is used as a base unit of a reception band (which may be called “unit band”). Also, the terminal may receive signals from different base stations in frequency bands or receive signals from the same base station supporting a plurality of frequency bands. If the terminal receives signals from the same base station, cell A and cell X in FIG. 1 are the same cell. Also, a “unit band” may be written as “component carrier(s)” in English in 3GPP LTE.

Further, a terminal has a plurality of RF receiving sections in each frequency band to perform spatial diversity reception or spatial multiplexing reception. For example, in a radio communication system to which the band aggregation scheme shown in FIG. 1 is applied, if a terminal performs spatial diversity reception by two antennas in each frequency band, the number of RF sections provided in the terminal is four in total of two in the 2 GHz band and two in the 3.4 GHz.

However, in a mobile communication system, if a terminal can access a certain base station and start communication, a case is possible where the signal power between the terminal and the base station varies due to the move of the terminal or the move of surrounding screens. Therefore, the terminal needs to always measure the signal power from nearby base stations and be prepared for base station switching (i.e. handover).

However, in a mobile communication system using a single frequency band, the center frequency of the frequency band used in the base station that is currently accessed (i.e. source base station), is not always the same as the center frequency of the frequency band used in a base station that is located nearby (i.e. base station of a handover destination candidate), and, consequently, it is difficult for a terminal to measure the signal power from nearby base stations while accessing the source base station.

Therefore, in the 3GPP LTE system using a single frequency band in the same way, a method is defined for measuring the signal power from nearby base stations (i.e. measurement) while a terminal continues communication with a source base station.

FIG. 2 illustrates the measurement defined in 3GPP LTE. As shown in FIG. 2, upon starting communication with a certain terminal in a unit band in use, a 3GPP LTE base station designates the mobile station to move the center frequency during a 6-ms period (hereinafter referred to as “measurement interval”) once every 40 ms and measure the signal power from a different base station in a band outside the used unit band (hereinafter referred to as “measurement on an unused unit band”). In this measurement interval, the base station stops transmitting data signals by not allocating downlink data signals (including a downlink control signal (PDCCH) and a data signal (PDSCH)) to that terminal. Therefore, that terminal can switch the center frequency and measure the signal power of a base station that is present in another unit band, without problems. Also, even if a certain terminal is implementing extra-unit-band measurement, another terminal can receive a downlink data signal, and, consequently, it is possible to allocate a downlink data signal for another terminal.

Also, since there is a base station that performs communication using the same unit band as that of a source base station, a terminal measures the signal power from another base station while communicating with the source base station (corresponding to the PDCCH/PDSCH reception parts in FIG. 2) (hereinafter referred to as “intra-unit-band measurement”). This intra-unit-band measurement is implemented with reference to the reception power of SCH (Synchronization CHannel) and RS (Reference Signal) transmitted from 1.0 the base station. These signals are code-multiplexed between base stations, so that the terminal can measure the power of signals transmitted from another base station in the same unit band while communicating with the source base station.

### CITATION LIST

### Patent Literature

3GPP TS 36.211 V8.3.0, “Physical Channels and Modulation (Release 8),” May 2008

### SUMMARY OF INVENTION

### Technical Problem

However, a measurement result is used to predict reception performance of downlink data signals. Therefore, in order to reduce errors in reception performance prediction, it is necessary to provide conditions for measurement and data signal reception, that is, it is necessary to make the number of antennas and the number of RF receiving sections used for measurement and data signal reception the same. That is, in the 3GPP LTE system, in either extra-unit-band measurement or intra-unit-band measurement, a terminal measures the reception power of reference signals using the same number of RF receiving sections as in data signal reception. Therefore, in the case of extra-unit-band measurement, it is necessary to stop signal transmission from a source base station to that terminal as described above.

Consequently, in the 3GPP LTE system, if transmission data for that terminal is produced on the base station side, transmission delay for a measurement interval occurs depending on the timing of data occurrence, which causes a problem of reducing QoS.

It is therefore an object of the present invention to provide a radio receiving apparatus that can maintain QoS while implementing measurement, and a measurement method of a reference signal on an unused unit band, in a radio communication system that transmits a series of data signal sequences using at the same time a first frequency band and a second frequency band each including a plurality of unit bands.

### Solution to Problem

The radio receiving apparatus of the present invention that can receive a series of data signal sequences using at a same time a first frequency band and a second frequency band each including a plurality of unit bands, employs a configuration having: a first radio frequency set that receives a radio frequency signal transmitted in the first frequency band; a second radio frequency set that receives a radio frequency signal transmitted in the second frequency band; a data receiving section that receives a data signal transmitted using a first used unit band included in the first frequency band among reception signals received in the first radio frequency set, in a first data reception interval, and receives a data signal transmitted using a second used unit band included in the second frequency band among reception signals received in the second radio frequency set, in a second data reception interval; and a reception power measuring section that measures a reception power of a reference signal on an unused unit band transmitted in a unit band different from the first used unit band and the second used unit band, in a measurement interval which overlaps the first data reception interval and which is temporally separated from the second data reception interval.

The measurement method of a reference signal on an unused unit band of the present invention includes the steps of: receiving a data signal transmitted using a first used unit band in a first frequency band including a plurality of unit bands, via a first radio frequency set in a first data reception interval, and receiving a data signal transmitted using a second used unit band in a second frequency band including a plurality of unit bands, via a second radio frequency set in a second data reception interval; and measuring a reception power of the reference signal on the unused unit band transmitted in a unit band different from the first used unit band and the second used unit band, in a measurement interval, where the measurement interval overlaps the first data reception interval and is temporally separated from the second data reception interval.

### Advantageous Effects of Invention

According to the present invention, it is possible to provide a radio receiving apparatus that can maintain QoS while implementing measurement, and a measurement method of a reference signal on an unused unit band, in a radio communication system that transmits a series of data signal sequences using at the same time a first frequency band and a second frequency band each including a plurality of unit bands.

### BRIEF DESCRIPTION OF DRAWINGS

FIG. 1 illustrates a band aggregation scheme;

FIG. 2 illustrates the measurement defined in 3GPP LTE;

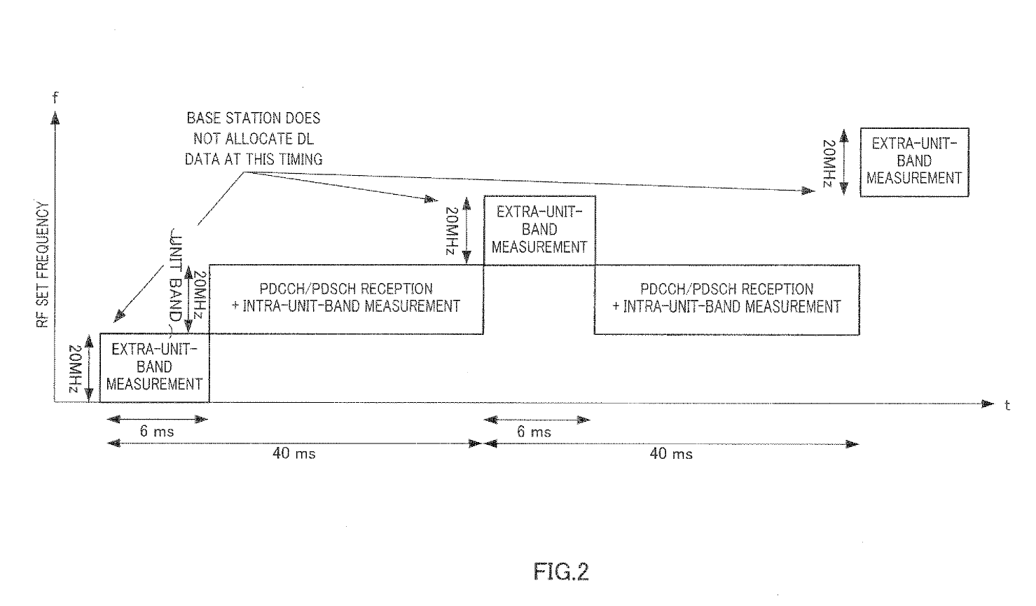

FIG. 3 is a block diagram showing a configuration of a terminal according to Embodiment 1 of the present invention;

FIG. 4 is a block diagram showing a configuration of a base station apparatus according to Embodiment 1 of the present invention;

FIG. 5 illustrates operations of a communication priority mode of a terminal according to Embodiment 1 of the present invention;

FIG. 6 illustrates operations of a communication priority mode of a terminal according to Embodiment 2 of the present invention;

FIG. 7 illustrates operations of a communication priority mode of a terminal according to Embodiment 3 of the present invention; and

FIG. 8 illustrates the mode switching of a terminal according to Embodiment 4 of the present invention.

### DESCRIPTION OF EMBODIMENT

Now, embodiments of the present invention will be explained in detail with reference to the accompanying drawings. Also, in embodiments, the same components will be assigned the same reference numerals and their explanation will be omitted.

### Embodiment 1

### [Terminal Configuration]

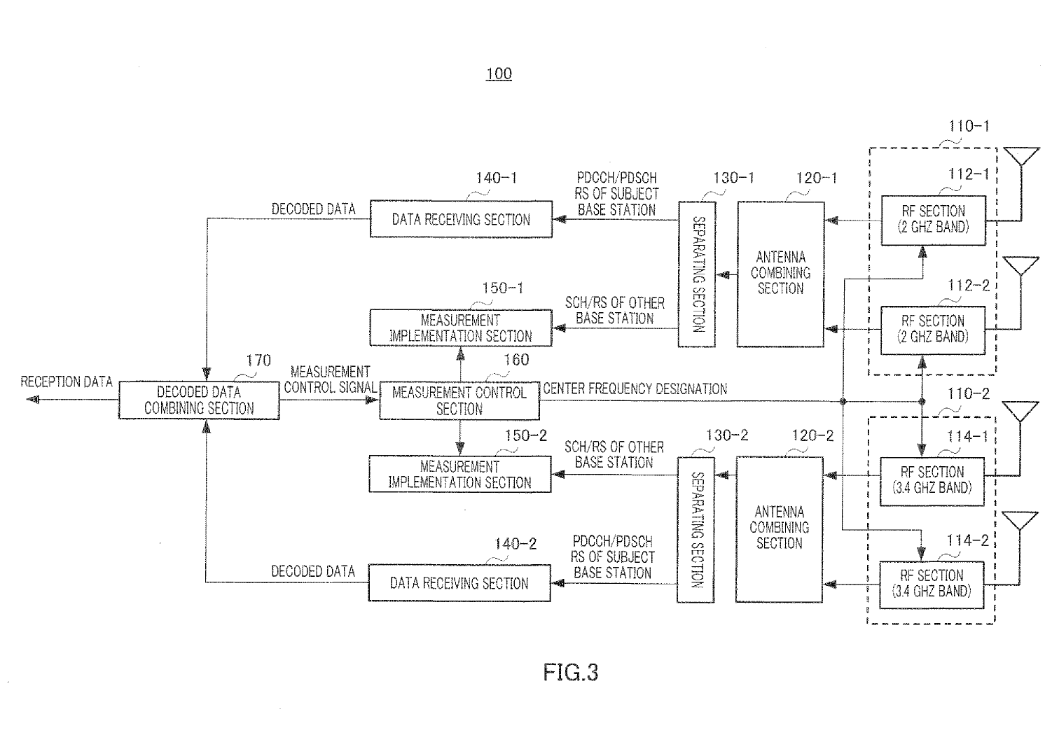

FIG. 3 is a block diagram showing a configuration of terminal 100 according to Embodiment 1. Terminal 100 is configured to be able to receive a series of data signal sequences using at the same time a first frequency band and a second frequency band each including a plurality of unit bands. That is, terminal 100 receives a series of data signal sequences transmitted in a band aggregation scheme. For example, the first frequency band is a 2 GHz band and the second frequency band is a 3.4 GHz band.

In FIG. 3, terminal 100 is provided with RF section sets 110-1 and 110-2, antenna combining sections 120-1 and 120-2, separating sections 130-1 and 130-2, data receiving sections 140-1 and 140-2, measurement implementation sections 150-1 and 150-2, measurement control section 160 and decoded data combining section 170. Function blocks with code branch number “1” support the first frequency band, and function blocks with branch number “2” support the second frequency band.

RF section set 110-1 has a plurality of RF sections 112 that can perform reception in the first frequency band, and is configured to enable spatial diversity reception. Here, RF section set 110-1 has a pair of RF sections 112-1 and 112-2. Also, RF section set 110-2 has a plurality of RF sections 114 that can perform reception in the second frequency band, and is configured to enable spatial diversity reception. Here, RF section set 110-2 has a pair of RF sections 114-1 and 114-2.

RF sections 112-1 and 112-2 match the center frequencies of their reception bands with the center frequency of the unit band corresponding to a center frequency designation received from measurement control section 160. Similarly, RF sections 114-1 and 114-2 match the center frequencies of their reception bands with the center frequency of the unit band corresponding to a center frequency designation received from measurement control section 160.

Antenna combining section 120-1 combines a plurality of reception signals received in RF section set 110-1, and outputs the combined reception signal to separating section 130-1. Also, antenna combining section 120-2 combines a plurality of reception signals received in RF section set 110-2, and outputs the combined reception signal to separating section 130-2.

Separating section 130-1 separates signals included in the combined reception signal depending on the types, and outputs the separated signals to data receiving section 140-1 and measurement implementation section 150-1. Separation signals outputted to data receiving section 140-1 include downlink data signals (including a downlink control signal (PDCCH) and downlink data signal (PDSCH)) and reference signal (“RS”) transmitted in a unit band in use from the source base station with which terminal 100 is currently communicating. On the other hand, separated signals outputted to measurement implementation section 150-1 include a synchronization channel (“SCH”) and reference signal (“RS”) transmitted in a band outside the unit band in use from a base station different from the source base station.

Separating section 130-2 separates signals included in the combined reception signal depending on the types, and outputs the separated signals to data receiving section 140-2 and measurement implementation section 150-2. Separation signals outputted to data receiving section 140-2 include downlink data signals (including a downlink control signal (PDCCH) and downlink data signal (PDSCH)) and reference signal (“RS”) transmitted in a unit band in use from the source base station with which terminal 100 is currently communicating. On the other hand, separated signals outputted to measurement implementation section 150-2 include a synchronization channel (“SCH”) and reference signal (“RS”) transmitted in a band outside the unit band in use from a base station different from the source base station.

Data receiving section 140-1 receives downlink data signals from separating section 130-1 in the first data reception interval. That is, in the first data reception interval, data receiving section 140-1 receives data signals transmitted using unit bands in use included in the first frequency band (hereinafter referred to as “first used unit bands”) among the reception signals received in RF section set 110-1. To be more specific, data receiving section 140-1 performs blind reception of a PDCCH in the first data reception interval, damasks CRC by the UE-ID allocated to terminal 100 and extracts a reception signal for which the CRC result is “OK,” as a PDCCH for terminal 100. Further, data receiving section 140-1 performs reception processing such as demodulation, decoding and error check of data, based on allocation information and MCS information included in the extracted PDCCH. Then, data that has been decoded is outputted to decoded data combining section 170.

Data receiving section 140-2 receives downlink data signals from separating section 130-2 in the second data reception interval. That is, in the first data reception interval, data receiving section 140-2 receives data signals transmitted using unit bands in use included in the second frequency band (hereinafter referred to as “second used unit bands”) among the reception signals received in RF section set 110-2. To be more specific, data receiving section 140-2 performs blind reception of a PDCCH in the second data reception interval, damasks CRC by the UE-ID allocated to terminal 100 and extracts a reception signal for which the CRC result is “OK,” as a PDCCH for terminal 100. Further, data receiving section 140-2 performs reception processing such as demodulation, decoding and error check of data, based on allocation information and MCS information included in the extracted. PDCCH. Then, data that has been decoded is outputted to decoded data combining section 170.

Measurement implementation section 150-1 measures the reception power of a reference signal on an unused unit band (an extra-use-unit-band reference signal) transmitted in a unit band different from the first used unit band and the second used unit band, in the first measurement interval which overlaps the second data reception interval and which is temporally separated from the first data reception interval.

Measurement implementation section 150-2 measures the reception power of a reference signal on an unused unit band transmitted in a unit band different from the first used unit hand and the second used unit band, in a second measurement interval which overlaps the first data reception interval and which is temporally separated from the second data reception interval.

Here, in SCH's received as input in measurement implementation sections 150-1 and 150-2, base-station-specific codes are used. Therefore, terminal 100 holds a code candidate group, finds a correlation between the code candidate group and a reception signal, and specifies the code candidate of the highest correlation. Based on this specified code candidate, one base station identification number is specified. This base station identification number is associated with a scrambling code, and, by using this scrambling code, measurement implementation sections 150-1 and 150-2 each can extract a reference signal transmitted from the base station corresponding to the base station identification number.

Measurement control section 160 generates measurement timing information and center frequency designation based on a measurement control signal. The measurement timing information is outputted to measurement implementation sections 150-1 and 150-2, and the center frequency designation is outputted to RF section sets 110-1 and 110-2.

Here, the measurement control signal includes a measurement period, measurement frequency position (indicating in which frequency position in a certain frequency band the SCH/RS needs to be captured to measure the signal power). Also, the measurement control signal may be transmitted together with data in the frequency band in which measurement is implemented, or may be transmitted together with data in other frequency bands than the frequency hand in which measurement is implemented.

To be more specific, measurement control section 160 determines the first measurement interval and the second measurement interval based on the measurement period included in the measurement control signal. Then, measurement control section 160 outputs the determined first measurement interval and second measurement interval to measurement implementation sections 150-1 and 150-2, respectively, as measurement timing information. Based on the measurement timing information outputted as above, measurement implementation sections 150-1 and 150-2 can implement measurement in the first measurement interval and the second measurement interval, respectively.

Also, measurement control section 160 generates a center frequency designation based on the measurement frequency position included in the measurement control signal, and outputs this center frequency designation to RF section sets 110-1 and 110-2. RF section sets 110-1 and 110-2 use the unit bands corresponding to the center frequency designation outputted as above, as reception target unit bands.

Decoded data combining section 170 combines the first frequency band decoded data obtained in data receiving section 140-1 and the second frequency band decoded data obtained in data receiving section 140-2, and transfers a series of data sequences obtained (i.e. reception data) to a higher layer. Here, the combined reception data includes a measurement control signal from a base station as data, and decoded data combining section 170 outputs this measurement control signal to measurement control section 160.

[Base Station Configuration]

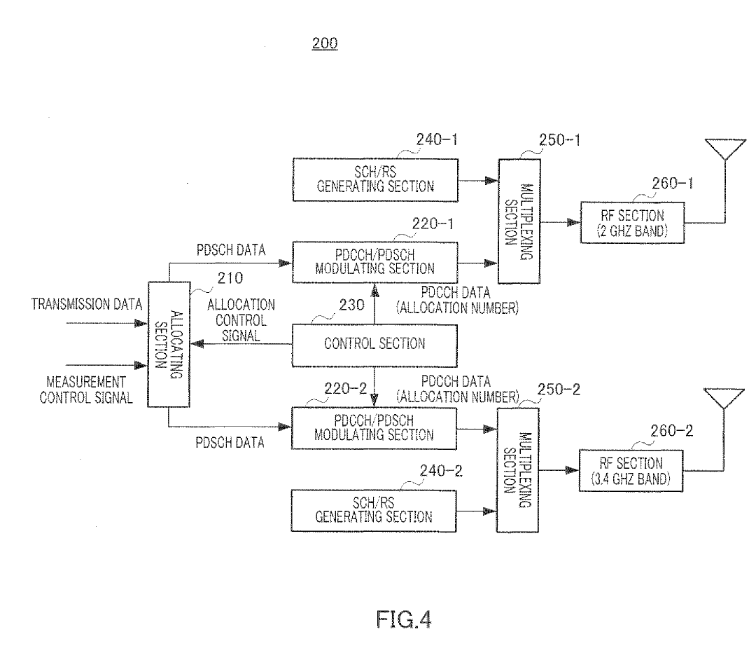

FIG. 4 is a block diagram showing a configuration of base station 200 according to Embodiment 1. Base station 200 is configured to be able to transmit a series of data signal sequences using at the same time a first frequency band and a second frequency band each including a plurality of unit bands. That is, base station 200 transmits a series of data signal sequences in a band aggregation scheme. For example, the first frequency band is a 2 GHz band and the second frequency band is a 3.4 GHz band.

In FIG. 4, base station 200 has allocating section 210, PDCCH/PDSCH modulating sections 220-1 and 220-2, control section 230, SCH/RS generating sections 240-1 and 240-2, multiplexing sections 250-1 and 250-2, and RF sections 260-1 and 260-2. Function blocks with code branch number “1” supports the first frequency band and function blocks with branch number “2” supports the second frequency band.

Allocating section 210 receives as input a measurement control signal and transmission data as one data signal. Allocating section distributes the input data signal to first frequency band resources and second frequency band resources based on an allocation control signal received from control section 230. Two distribution signals are outputted to PDCCH/PDSCH modulating section 220-1 and PDCCH/PDSCH modulating section 220-2, respectively, as PDSCH data signals.

PDCCH/PDSCH modulating sections 220-1 and 220-2 receive PDSCH data signals from allocating section 210 and PDCCH data signals from control section 230 and modulate the input signals. The modulated signals are outputted to multiplexing sections 250-1 and 250-2.

Control section 230 determines a frequency band to allocate to transmission destination terminal 100 and an allocation frequency position (i.e. used unit band) in the frequency band. Control section 230 outputs a signal for designating the determined allocation (i.e. allocation control signal) to allocating section 210. Also, control section 230 generates information related to the determined allocation as a PDCCH data signal. The CRC part of this PDCCH data signal is masked by the UE-ID allocated to transmission destination terminal 100, and then the result is outputted to PDCCH/PDSCH modulating sections 220-1 and 220-2.

SCH/RS generating sections 240-1 and 240-2 generate and output SCH and RS to multiplexing sections 250-1 and 250-2.

Multiplexing section 250-1 multiplexes the SCH and RS received from SCH/RS generating section 240-1 and the modulated signal received from PDCCH/PDSCH modulating section 220-1, and outputs the multiplexed signal to RF section 260-1. Multiplexing section 250-2 multiplexes the SCH and RS received from SCH/RS generating section 240-2 and the modulated signal received from PDCCH/PDSCH modulating section 220-2, and outputs the multiplexed signal to RF section 260-2.

RF sections 260-1 and 260-2 perform radio transmission processing of the multiplexed signals and then transmit them via antennas. Here, RF section 260-1 performs transmission in the first frequency band and RF section 260 performs transmission in the second frequency band.

[Operations of Terminal 100 and Base Station 200]

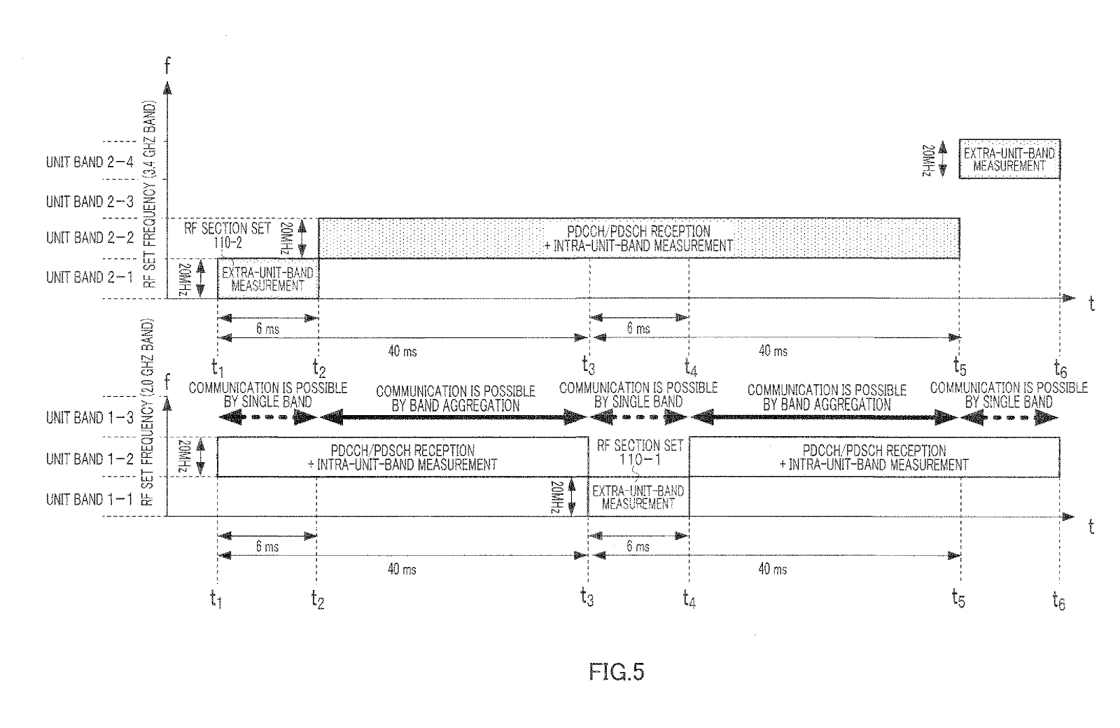

FIG. 5 illustrates operations of a communication priority mode of terminal 100.

First, base station 200 transmits PDCCH data signals as allocation information signals to terminal 100 in unit bands 1-2 and 2-2 used by terminal 100 for data communication with that base station. The content of that PDCCH data signal includes information indicating in which frequency position the data signals for that terminal in unit bands 1-2 and 2-2 are placed.

Also, base station 200 transmits a measurement control signal to terminal 100. The content of the measurement control signal includes a measurement period and measurement frequency position. In FIG. 5, a measurement period is 40 ms. Terminal 100 sets the measurement interval of each frequency band and the unit band in which measurement is implemented in each measurement interval, based on that measurement control signal.

In FIG. 5, first, in the second frequency band, the interval between time t1 and time t2 is set as a measurement interval (i.e. the above second measurement interval). Also, the unit band in which measurement is implemented in the measurement interval is unit band 2-1. Also, the interval between time t5 and time t6 is set as a measurement interval. The unit hand in which measurement is implemented in the measurement interval between time t5 and time t6 is unit band 2-4.

Then, the interval between time t2 to time t5, which does not overlap the measurement intervals, is set as an interval to receive downlink data signals in the second frequency band, that is, as the above second data reception interval. That is, in the second frequency band, the second data reception interval and the second measurement intervals are temporally separated.

On the other hand, the measurement interval between time t1 and time t2 (or between time t5 and time t6) in the second frequency band is set as an interval to receive downlink data signals in the first frequency band, that is, as the above first data reception interval. Also, the interval between time t3 and time t4, which does not overlap the first data reception interval, is set as the first measurement interval (here, the unit band in which measurement is implemented is unit band 1-1). This first measurement interval overlaps the second data reception interval.

That is, in the communication priority mode shown in FIG. 5, a measurement interval in one frequency band and a measurement interval in another frequency band are different temporally, and the time period corresponding to the measurement interval in one frequency band is a data reception interval in another frequency band. That is, terminal 100 performs data communication with source base station 200 in any frequency band at any timing. Thus, terminal 100 is in a state of being able to receive data at any timing, so that it is possible to prevent transmission delay from occurring in base station 200. Therefore, terminal 100 can maintain the QoS level in a system while implementing measurement.

As described above, according to the present embodiment, in terminal 100, measurement implementation section 150-1 measures the reception power of the reference signal on the unused unit band transmitted in a unit band different from the first used unit band in the first frequency band, in the first measurement interval which overlaps a second data reception interval and which is temporally separated from the first data reception interval.

By this means, terminal 100 can perform data communication with source base station 200 in any frequency band at any timing, so that it is possible to alleviate delay in downlink signal transmission. That is, it is possible to realize terminal 100 that can implement measurement while maintaining QoS.

Also, in terminal 100, measurement implementation section 150-2 measures the reception power of the reference signal on the unused unit band transmitted in a unit band different from a second used unit band in a second frequency band, in a second measurement interval which overlaps the first data reception interval and which is temporally separated from a second data reception interval.

Also, the above explanation only describes delay in downlink signal transmission. However, upon implementing extra-unit-band measurement, base station 200 cannot return a response signal for HARQ of uplink data signals. Therefore, the measurement method in a conventional 3GPP LTE system may cause delay in uplink data signals. By contrast with this, according to the present embodiment, it is possible to alleviate delay in uplink data signals.

Also, terminal 100 according to Embodiment 1 is effective in the following system. That is, it is a system in which base station 200 that can support a band aggregation scheme and a base station that cannot support the band aggregation scheme are present together. Base station 200 of the present embodiment is configured to be able to support the band aggregation scheme.

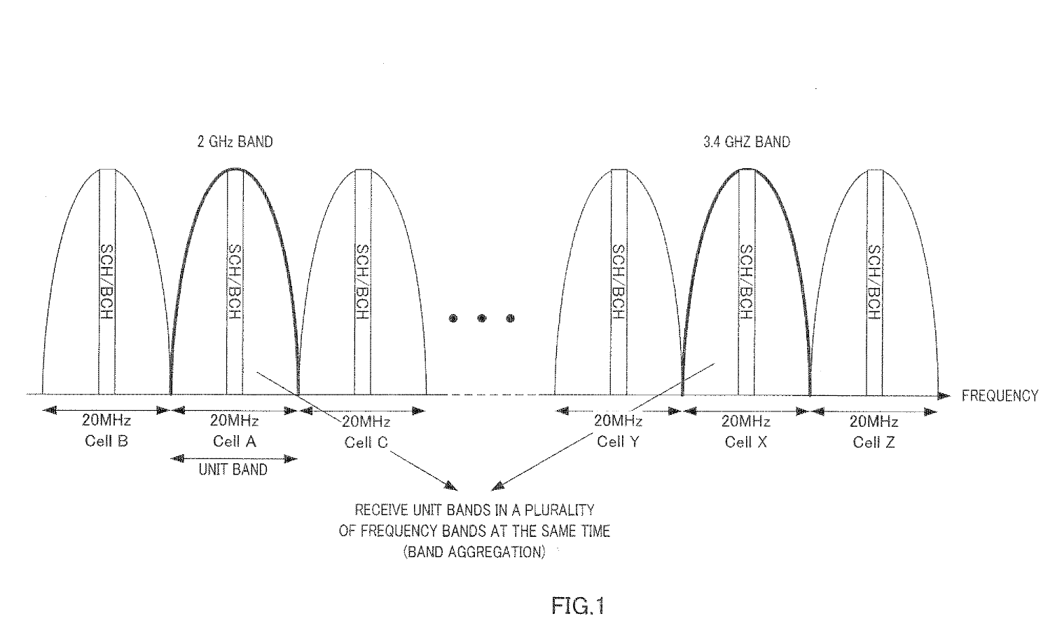

On the other hand, a base station that cannot support the band aggregation scheme and that supports only a 2 GHz band employs a configuration removing PDCCH/PDSCH modulating section 220-2, SCH/RS generating section 240-2, multiplexing section 250-2 and RF section 260-2 from FIG. 4. Also, a base station that cannot support the band aggregation scheme and that supports only a 3.4 GHz band employs a configuration removing PDCCH/PDSCH modulating section 220-1, SCH/RS generating section 240-1, multiplexing section 250-1 and RF section 260-1 from FIG. 1. In both cases, an SCH can be transmitted only in the frequency band supported by that station.

In this case, in order to recognize all base stations located nearby, terminal 100 needs to implement measurement in both the 2 GHz band and the 3.4 GHz band.

### Embodiment 2

In a terminal according to Embodiment 2, all RF sections forming at least one RF section set each can support a plurality of frequency bands. The basic configuration of the terminal according to the present embodiment is the same as the configuration of the terminal explained in Embodiment 1. Therefore, the terminal according to the present embodiment will be explained using FIG. 3 too.

In terminal 100 according to Embodiment 2, at least RF section set 110-2 is configured to be able to support the first frequency band in addition to a second frequency band. Therefore, depending on a reception target frequency band set in RF section set 110-2, antenna combining section 120-2, separating section 130-2, data receiving section 140-2 and measurement implementation section 150-2 perform processing related to signals transmitted in the first frequency band.

Also, in terminal 100 according to Embodiment 2, measurement implementation section 150-2 also implements unused band measurement in the first frequency band. Therefore, measurement implementation section 150-1 is not necessary.

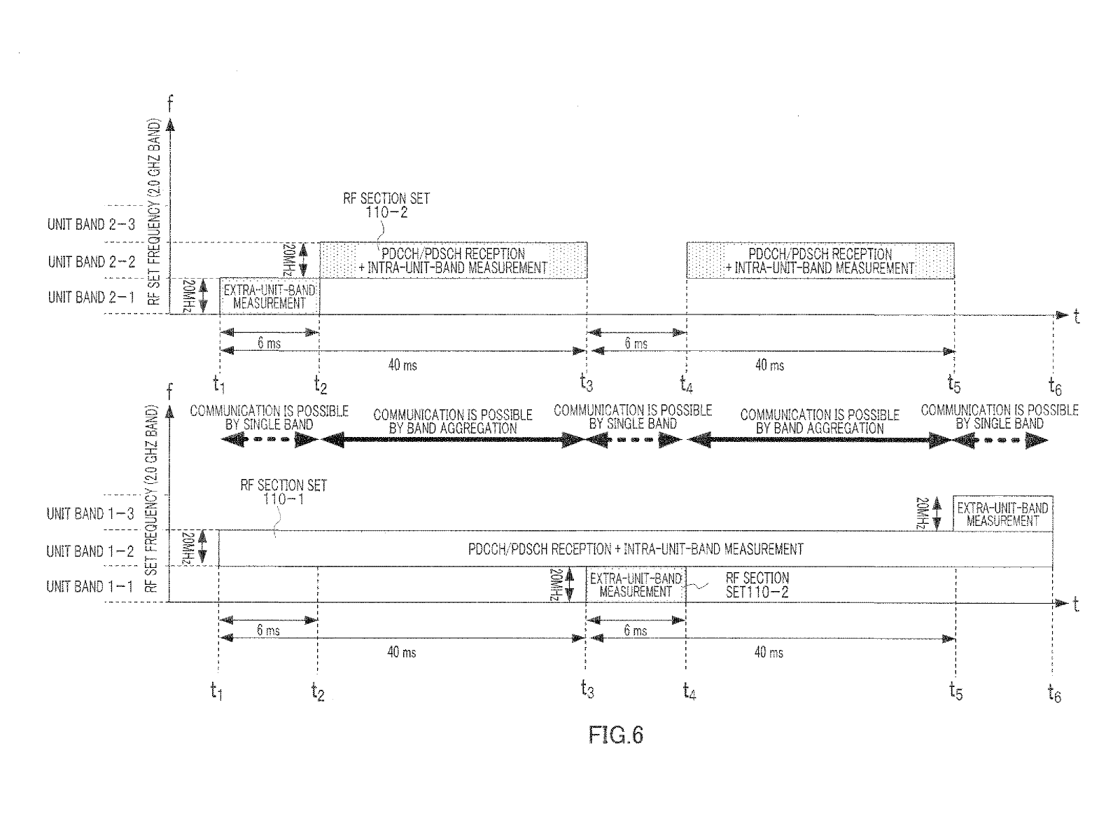

FIG. 6 illustrates operations of a communication priority mode of terminal 100 according to Embodiment 2.

In FIG. 6, a time period in which a measurement interval of unused unit band measurement is present, is the same in FIG. 5 of Embodiment 1. However, not only a second frequency band measurement but also a first frequency band measurement is implemented by RF section set 110-2 and measurement implementation section 150-2. According to this, RF section set 110-1 is in a state where a reception target band is set as the unit band in use.

As described above, according to the present embodiment, in terminal 100, measurement implementation section 150-2 measures the reception power of the reference signal on the unused unit band transmitted in a unit band different from the first used unit band and second used unit band, in a measurement interval which overlaps the first data reception interval and which is temporally separated from a second data reception interval.

By this means, terminal 100 can perform data communication with source base station 200 in any frequency band at any timing, so that it is possible to alleviate delay in downlink signal transmission. That is, it is possible to realize terminal 100 that can implement measurement while maintaining QoS.

In Embodiment 2, especially, a 2 GHz band in which distance attenuation is always small is used for data signal transmission, so that it is possible to improve the data reception performance of terminal 100. Also, signaling from a base station may designate that terminal 100 continues communication in a 2 GHz band. Alternatively, instead of signaling, a band to which signals that occur continuously like a VoIP call are allocated (i.e. a band in which allocation is performed by semi-persistent scheduling), may be set automatically.

### Embodiment 3

The terminal according to Embodiment 3 implements measurement only in one frequency band. The basic configuration of the terminal according to the present embodiment is the same as the configuration of the terminal explained in Embodiment 1. Therefore, the terminal according to the present embodiment will be explained using FIG. 3 too.

In terminal 100 according to Embodiment 3, only measurement implementation section 150-1 implements measurement. That is, terminal 100 according to Embodiment 3 implements measurement only in a 2 GHz band. Therefore, measurement implementation section 150-2 is not necessary.

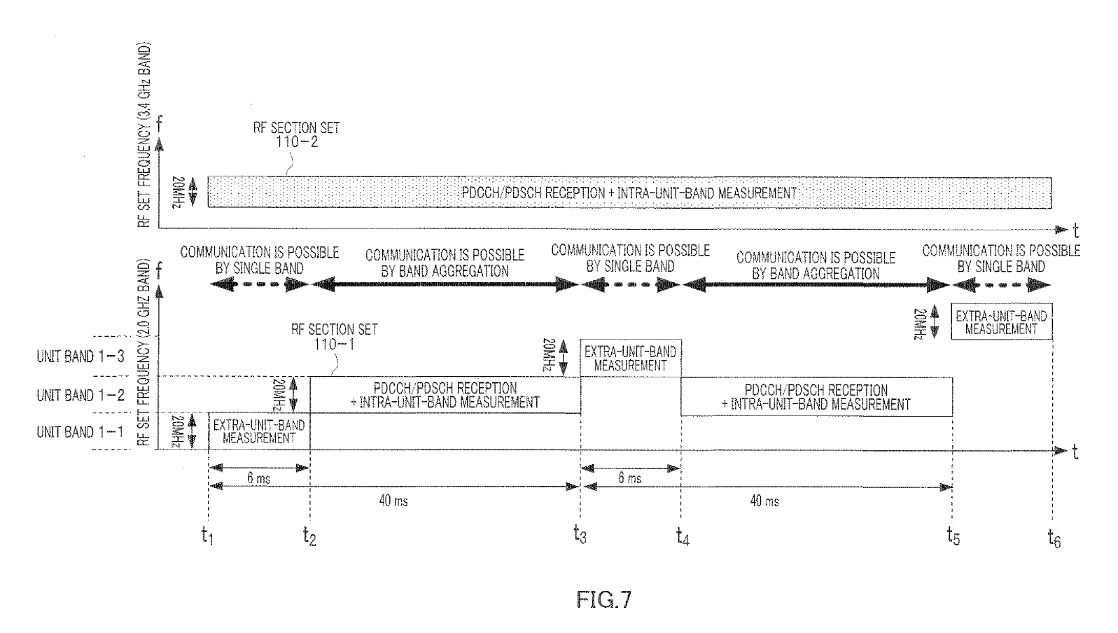

FIG. 7 illustrates operations of a communication priority mode of terminal 100 according to Embodiment 3.

In FIG. 7, a time period in which a measurement interval of unused unit band measurement is present, is the same in FIG. 5 of Embodiment 1. However, only measurement implementation section 150-1 implements measurement. According to this, RE section set 110-2 is in a state where a reception target band is set to a unit band in use.

As described above, according to the present embodiment, in terminal 100, measurement implementation section 150-1 measures the reception power of the reference signal on the unused unit band transmitted in a unit band different from the first used unit band in the first frequency band, in a measurement interval which overlaps a second data reception interval and which is temporally separated from the first data reception interval.

By this means, terminal 100 can perform data communication with source base station 200 in any frequency band at any timing, so that it is possible to alleviate delay in downlink signal transmission. That is, it is possible to realize terminal 100 that can implement measurement while maintaining QoS.

Here, terminal 100 according to Embodiment 3 is effective in the following system. That is, it is effective to a system in which all base stations including a source base station and a base station of a handover destination candidate support a 2 GHz band reliably, and an SCH is transmitted reliably in the 2 GHz band. This is because, in this system, terminal 100 can find all nearby base stations only by implementing measurement in the 2 GHz band without implementing measurement in a 3.4 GHz band.

For example, in a case where the same base station transmits an SCH and RS in both the 2 GHz band and 3.4 GHz band, although base stations are searched for redundantly and unnecessarily in Embodiment 1, in the same way as in Embodiment 3, terminal 100 can search for all nearby base stations efficiently. In this case, an intra-use-unit-band measurement in the 3.4 GHz band may be implemented or may not be implemented.

### Embodiment 4

In Embodiment 4, the communication priority mode explained in Embodiments 1 to 3 and a measurement priority mode are switched. The basic configuration of a terminal according to the present embodiment is the same as the configuration of the terminal explained in Embodiment 1. Therefore, the terminal according to the present embodiment will be explained using FIG. 3 too.

Terminal 100 according to Embodiment 4 implements measurement while switching modes between a communication priority mode and a measurement priority mode. Here, as explained in Embodiments 1 to 3, the communication priority mode is the mode in which data communication is performed with source base station 200 in any frequency band at any timing. On the other hand, the measurement priority mode is the mode in which measurement intervals in all frequency bands are matched.

This mode switching is performed under control by measurement control section 160 based on a measurement control signal. That is, if measurement timing information outputted from measurement control section 160 to measurement implementation sections 150-1 and measurement timing information outputted from measurement control section 160 to measurement implementation sections 150-2 are matched, the measurement priority mode is set.

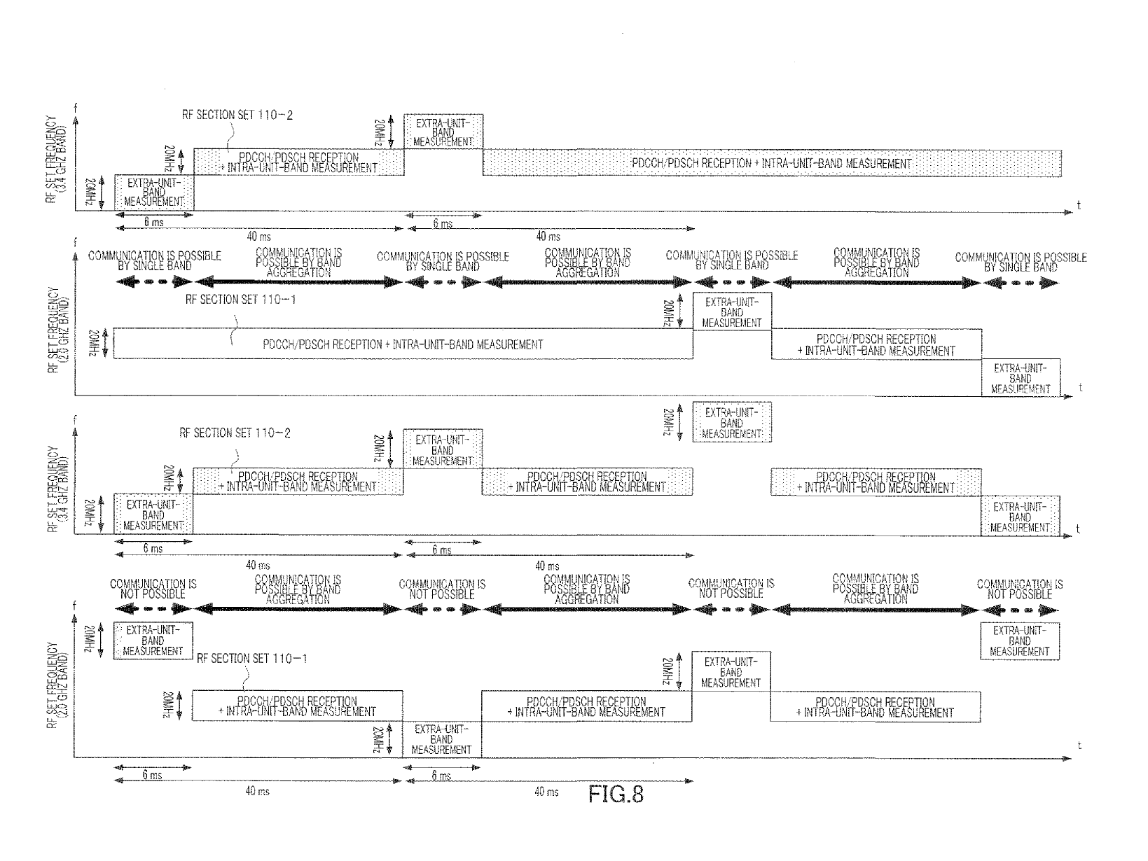

FIG. 8 illustrates the mode switching of terminal 100 according to Embodiment 4.

In FIG. 8, in a communication priority mode, as in Embodiment 1, measurement implementation section 150-1 measures the reception power of the reference signal on the unused unit band transmitted in a unit band different from the first used unit band in the first frequency band, in a measurement interval which overlaps a second data reception interval and which is temporally separated from the first data reception interval, and measurement implementation section 150-2 measures the reception power of the reference signal on the unused unit band transmitted in a unit band different from a second used unit band in a second frequency band, in a second measurement interval which overlaps the first data reception interval and which is temporally separated from a second data reception interval.

In contrast, in a measurement priority mode, the first measurement interval and the second measurement interval are the same interval. That is, in the measurement priority mode, terminal 100 implements measurement at high speed by operating all RF section sets at the same time.

As described above, according to the present embodiment, in terminal 100, measurement control section 160 switches between a communication priority mode and a measurement priority mode. This mode switching is performed based on the distance between terminal 100 and source base station 200 or the communication quality between terminal 100 and source base station 200.

By this means, for example, in a case where a handover preparation needs to be completed as soon as possible because communication quality is degraded due to terminal 100 located in the cell edge, by setting a measurement priority mode, terminal 100 can complete a handover preparation before it becomes no longer possible to continue communication. Therefore, disadvantages such as communication cut-off in terminal 100 are reduced. Also, for example, in a case where much downlink data occurs terminal 100 is present in the cell center part, a handover needs not be prepared soon, so that it is possible to suppress transmission delay of downlink signals by using a communication priority mode.

### Other Embodiment

Although RF section sets supporting respective frequency hands each implement measurement at the same time in explanation of Embodiments 1 to 4, it is possible to realize faster measurement by operating these RF section sets independently.

Also, although a unit band is explained as a 20 MHz band in the explanation of Embodiments 1 to 4, the scale of a unit band is not limited to 20 MHz. Also, although an SCH is included near the center of a unit band, an SCH is not necessarily included near the center. In short, a frequency unit recognized as one closed band is a unit band and is defined by, for example, the frequency unit including a null carrier in the center, broadening of a control channel such as a PDCCH in the frequency domain, or the unit including a BCH. Also, information required to implement measurement is the center frequency of SCH of a base station in another cell, and therefore the band of a measurement target unit band may not be expressly designated.

Also, although a measurement control signal for a terminal is transmitted together with data via a PDSCH, for example, a measurement control signal may be transmitted via a control channel such as a PDCCH.

Also, in Embodiments 1 to 4, when terminal 100 implements measurement in a communication priority mode, at the timing measurement is not performed, it is necessary to search for both a PDCCH for band aggregation and a PDCCH in which band aggregation is not implemented. In contrast, at the timing measurement is implemented, a base station and the terminal cannot perform communication in a band aggregation scheme. That is, at the timing measurement is implemented, base station 200 does not transmit a control signal for band aggregation to terminal 100, so that terminal 100 needs not perform blind reception of a PDCCH for band aggregation at that timing. That is, the terminal can reduce the number of times of blind reception of a PDCCH at the measurement implementation timing, and, as a result, it is possible to suppress power consumption.

Although example cases have been described above with Embodiments 1 to 4 where the present invention is implemented with hardware, the present invention can be implemented with software.

Furthermore, each function block employed in the description of each of Embodiments 1 to 4 may typically be implemented as an LSI constituted by an integrated circuit. These may be individual chips or partially or totally contained on a single chip. “LSI” is adopted here but this may also be referred to as “IC,” “system LSI,” “super LSI,” or “ultra LSI” depending on differing extents of integration.

Further, the method of circuit integration is not limited to LSI's, and implementation using dedicated circuitry or general purpose processors is also possible. After LSI manufacture, utilization of an FPGA (Field Programmable Gate Array) or a reconfigurable processor where connections and settings of circuit cells in an LSI can be regenerated is also possible.

Further, if integrated circuit technology comes out to replace LSI's as a result of the advancement of semiconductor technology or a derivative other technology, it is naturally also possible to carry out function block integration using this technology. Application of biotechnology is also possible.

The disclosure of Japanese Patent Application No. 2008-183732, filed on Jul. 15, 2008, including the specification, drawings and abstract, is incorporated herein by reference in its entirety.

### INDUSTRIAL APPLICABILITY

The radio receiving apparatus and the reference signal on the unused unit band measurement method of the present invention are useful to maintain QoS while implementing measurement in a radio communication system to transmit a series of data signal sequences using at the same time the first frequency band and second frequency band each including a plurality of unit bands.

1-4. (canceled)

5. A radio receiving apparatus comprising:
a data receiving section that receives a data signal transmitted using a first used unit band included in a first frequency band comprising a plurality of unit bands, in a first data reception interval, and receives a data signal transmitted using a second used unit band included in a second frequency band including a plurality of unit bands, in a second data reception interval; and
a reception power measuring section that measures a reception power of a reference signal on an unused unit band transmitted in a unit band different from the first used unit band and the second used unit band, in a first measurement interval,
wherein the first measurement interval is time division multiplexed with the second data reception interval and set independently from the first data reception interval.

6. The radio receiving apparatus according to claim 5, wherein the first measurement interval is time division multiplexed with the second data reception interval and set to overlap the first data reception interval.

7. The radio receiving apparatus according to claim 6, wherein the reception power measuring section is a second frequency band measuring section that measures the reception power of the second frequency band, and further comprises a first frequency band measuring section that measures a reception power of the reference signal on the unused unit band in the first frequency band in a communication priority mode to perform the measurement in the first data reception interval and a second measurement interval which is time division multiplexed with the first measurement interval.

8. The radio receiving apparatus according to claim 7, further comprising a measurement control section that switches between the communication priority mode and a measurement priority mode in which the first measurement interval and the second measurement interval are a same interval.

9. A radio receiving method comprising:
receiving a data signal transmitted using a first used unit band included in a first frequency band comprising a plurality of unit bands, in a first data reception interval, and receiving a data signal transmitted using a second used unit band included in a second frequency band including a plurality of unit bands, in a second data reception interval; and
measuring a reception power of a reference signal on an unused unit band transmitted in a unit band different from the first used unit band and the second used unit band, in a first measurement interval,
wherein the measurement interval overlaps the first data reception interval and is time division multiplexed with the second data reception interval.
